(19) United States
(12) Patent Application Publication
(10) Pub. No.: US 2026/0267283 A1
(43) Pub. Date: Sep. 10, 2026

(54) METHOD FOR MANUFACTURING A DIFFRACTIVE OPTICAL ELEMENT AND APPARATUS FOR MANUFACTURING A DIFFRACTIVE OPTICAL ELEMENT

(71) Applicant: AlphaLum SA, Lausanne (CH)

(72) Inventors: Carlos Macias, Pully (CH); Robin Kaech, Ecublens (CH); Frédéric Montfort, Froideville (CH); Jan Dedic, Lausanne (CH)

(21) Appl. No.: 19/166,521

(22) PCT Filed: Feb. 22, 2024
(86) PCT No.: PCT/EP2024/054502

§ 371 Date: Sep. 18, 2025

(30) Foreign Application Priority Data
Mar. 22, 2023 (DE) 10 2023 107 190.4

(51) Int. Cl. G03H 1/02

(52) U.S. Cl. CPC G03H 1/0248; G03H 2260/12

(57) ABSTRACT

An apparatus and method for manufacturing a diffractive optical element wherein the method includes providing a master of the diffractive optical element, wherein a layer of a recordation material covers the master, radiating the master with electromagnetic radiation of a reference beam, such that an object beam is generated, and recording an interference pattern of the electromagnetic radiation of the reference beam and an electromagnetic radiation of the object beam by the recordation material.

### BACKGROUND OF THE INVENTION

A method for manufacturing a diffractive optical element and an apparatus for manufacturing a diffractive optical element are provided.

Particularly, an improved method for manufacturing a diffractive optical element is to be provided. Further, an apparatus for improved manufacturing of a diffractive optical element is to be provided.

### SUMMARY OF THE INVENTION

According to an embodiment of the method for manufacturing a diffractive optical element, a master of the diffractive optical element is provided. Particularly, the master is duplicated and/or copied during the method. In other words, the diffractive optical element to be manufactured with the present method is particularly a copy of the master. For example, the master is a volume phase hologram. Since the diffractive optical element to be manufactured is particularly a copy of the master, features and embodiments disclosed in connection with the master can also be embodied in connection with the diffractive optical element and vice versa.

Particularly, the master has, at least substantially, the form of a plate with a first main surface and a second main surface opposite to the first main surface. Preferably, the first main surface and the second main surface are parallel to each other. Particularly, a thickness of the master is defined by a distance between the first main surface and the second main first surface. The main first main surface and the second main surface limit a volume region of the master. The main first main surface and the second main surface are particularly parallel to a main extension plane of the master.

According to an embodiment of the method, the master includes an active optical structure, which is to be copied by the present method. With the term “active optical structure” it is indicated that the active optical structure has an impact on electromagnetic radiation impinging and/or passing through the active optical structure. For example, the active optical structure diffracts or reflects electromagnetic radiation. For example, the active optical structure has an imaging, magnifying and/or demagnifying function on the electromagnetic radiation. Particularly, the electromagnetic radiation to be affected by the active optical structure is in the visible spectral range and/or the UV spectral range and/or infrared spectral range.

The active optical structure includes, for example, periodically arranged structure elements, such as parallel equidistant grooves or line elevations. For example, the active optical structure is a grating. For example, the active optical structure is completely comprised by the volume region of the master or is partially part of a surface of the master. In the latter case, the first main surface and/or the second main surface of the master is at least partially structured. For example, the optical structure includes or consists of a surface relief grating. Particularly, the active optical structure carries an optical information of the master.

According to a further embodiment of the method, a layer of a recordation material covers the master, preferably completely. Particularly, the layer of the recordation material covers the first main surface of the master and/or the second main surface of the master, preferably completely in plan view. If the layer of the recordation material covers the first main surface and/or the second main surface of the master completely, the first main surface and/or the second surface is not freely accessible.

If the active optical structure of the master extends in the first main surface and/or the second main surface, such that the first main surface and/or the second main surface is structured, the layer of the recordation material is so thick that the structure is completely planarized. Particularly, the layer of the recordation material is so thick that it extends above the structure in a direction normal to the main extension plane of the master and has a continuous sub-layer of recordation material above the structured first main surface and/or the structured second main surface. Within the sub-layer, the active optical structure is recorded during the method. For example, the sub-layer has a thickness between 1 micrometer and 300 micrometer, limits inclusive.

According to a further embodiment of the method, the master is radiated with electromagnetic radiation of a reference beam, such that an object beam is generated. The electromagnetic radiation of the reference beam and/or an electromagnetic radiation of the object beam particularly has a low coherence length. The electromagnetic radiation of the reference beam and/or the electromagnetic radiation of the object beam is, for example, from the visible and/or UV and/or infrared spectral range. Particularly, the electromagnetic radiation of the reference beam and/or the electromagnetic radiation of the object beam is from a spectral range to be affected by the active optical structure of the master. Particularly, the electromagnetic radiation of the object beam is correlated in time and phase with the electromagnetic radiation of the reference beam.

According to a further embodiment of the method, an interference pattern of the electromagnetic radiation of the reference beam and the electromagnetic radiation of the object beam is recorded by the recordation material. The interference pattern is formed by interference of the electromagnetic radiation of the reference beam and the electromagnetic radiation of the object beam. For interference the electromagnetic radiation of the reference beam and the electromagnetic radiation of the object beam have to overlap at least partially. Furthermore, the electromagnetic radiation of the reference beam and the electromagnetic of the object beam have to be correlated in phase and time to each other in order to form an interference pattern.

Particularly, the method for manufacturing the diffractive optical element includes the steps:
providing the master of the diffractive optical element, wherein the layer of the recordation material covers the master,
radiating the master with the electromagnetic radiation of the reference beam, such that the object beam is generated, and
recording the interference pattern of the electromagnetic radiation of the reference beam and the electromagnetic radiation of the object beam by the recordation material.

Particularly, radiation of the master, generation of the object beam and recordation of the interference pattern happen simultaneously. In such a way an optical path difference of the object beam and the reference beam is preserved during transfer of an optical information of the master so that the coherence length of the electromagnetic radiation of the reference beam/and or the coherence length of the electromagnetic radiation of the object beam is not of significance.

According to a further embodiment of the method, the diffractive optical element to be manufactured is a volume phase hologram. In that case, the master is also a volume phase hologram. If the master to be copied is a volume phase hologram, the thickness of the recordation material is much larger than the wavelength of the electromagnetic radiation of the reference beam and/or the electromagnetic radiation of the object beam.

Particularly, the impact of the active optical structure of the volume phase hologram on impinging/passing electromagnetic radiation, for example from the reference beam, is only Bragg diffraction. Particularly, the volume phase hologram diffracts, at least substantially, all electromagnetic radiation of the reference beam in electromagnetic radiation of the object beam.

According to a further embodiment of the method, the electromagnetic radiation of the reference beam is emitted by a light source. Particularly, the light source emits visible light and/or light of the ultraviolet spectral range and/or light of the infrared spectral range. Particularly, the electromagnetic radiation emitted by the light source has a low coherence length. For example, the coherence length of the electromagnetic radiation of the reference beam does not exceed 500 micrometer or 50 micrometer or 5 micrometer.

Particularly, the light source is a light-emitting diode or a semiconductor laser. The light-emitting diode particularly includes a light-emitting diode chip based on a semiconductor material. The light-emitting diode chip includes an active region having a pn-junction and/or heterostructures of quantum wells. When electrical current is applied to the light-emitting diode chip, electromagnetic radiation is generated within the active region by spontaneous emission. Electromagnetic radiation generated within the active region of the light-emitting diode chip has, for example, a spectral width of 5 nanometer to 10 nanometer, limits included or 2 nanometer to 20 nanometer, limits included. Electromagnetic radiation generated by a light-emitting diode particularly has a low coherence length, since it is generated by spontaneous emission.

The semiconductor laser includes a semiconductor laser chip based on a semiconductor material. The semiconductor laser chip also has an active region as an electromagnetic radiation generating element as the light-emitting diode chip. The active region is arranged within a resonator, leading to population inversion within the active region during operation of the semiconductor laser chip. During operation of the semiconductor laser chip, electromagnetic radiation is generated within the active region by stimulated emission leading to coherent electromagnetic laser radiation. For example, the laser chip is an edge-emitting semiconductor laser diode chip or a vertical cavity surface-emitting laser chip (VCSEL).

According to a further embodiment of the method, the recordation material is a photopolymer. For example, the photopolymer includes monomers, which are exposed by the interference pattern of the electromagnetic radiation of the reference beam and the electromagnetic radiation of the object beam such that the interference pattern is recorded within the photopolymer. The monomers of the photopolymer are polymerized due to the exposure to the interference pattern. For example, the layer of the recordation material is deposited on a carrier, such as a glass plate or a plastic plate. After recordation of the interference pattern, the photopolymer is particularly developed in a further step.

According to a further embodiment of the method, the master generates the electromagnetic radiation of the object beam such that a coherence volume of the electromagnetic radiation of the reference beam and a coherence volume of the electromagnetic radiation of the object beam overlap, preferably completely. Particularly, a projection of the coherence volume of the electromagnetic radiation of the reference beam and a projection of the coherence volume of the electromagnetic radiation of the object beam on the recordation material overlap, preferably completely. By the overlap of the coherence volume of the electromagnetic radiation of the reference beam and the coherence volume of the electromagnetic radiation of the object beam, the interference pattern is generated.

According to a further embodiment of the method, the coherence volume of the electromagnetic radiation of the reference beam and the coherence volume of the electromagnetic radiation of the object beam overlap within the recordation material. In such a way, a three-dimensional interference pattern is created within the recordation material. The recordation material records the interference pattern by polymerizing the monomers of the photopolymer due to the exposure within the interference pattern.

The volume of the recordation material is, for example, part of the layer of the recordation material having a specific thickness. Particularly, the thickness of the layer of the recordation material, for example disposed on a carrier, is smaller than the coherence length of the electromagnetic radiation of the reference beam and/or the coherence length of the electromagnetic radiation of the object beam.

According to a further embodiment of the method, the interference pattern is formed by the overlap of the coherence volume of the electromagnetic radiation of the reference beam with the coherence volume of the electromagnetic radiation of the object beam.

According to a further embodiment of the method, the master is reflective for the electromagnetic radiation of the reference beam, at least partially. For example, the master reflects at least 50% or at least 80% or at least 90% of the electromagnetic radiation of the reference beam. Particularly, the object beam is reflected by the active optical structure of the master in a half-space limited by the main extension plane of the master, the half-space including the light source emitting the reference beam. The object beam is generated by the reflection of the reference beam. Further, during reflection of the electromagnetic radiation of the reference beam on the active optical structure, the optical information of the active optical structure is transferred to the electromagnetic radiation such that the object beam is generated. The electromagnetic radiation of the object beam carries the optical information of the active optical structure due to the reflection. In other words, the reference beam as emitted by the light source impinges on the master and, during interaction of the reference beam with the active optical structure of the master, the object beam is created and reflected in the half-space, wherein the light source is arranged.

Further, simultaneously with the generation of the object beam, the electromagnetic radiation of the object beam and the electromagnetic radiation of the reference beam overlap, preferably completely, and form the interference pattern recorded by the layer of the recordation material on or over the master.

According to a further embodiment of the method, the layer of the recordation material is arranged on or over a main surface of the master facing the half-space with the light source. This is particularly the case, if the master is reflective for the electromagnetic radiation of the reference beam.

According to a further embodiment of the method, the master is transmissive for the electromagnetic radiation of the reference beam, at least partially. For example, the master transmits electromagnetic radiation of the reference beam of at least 50% or at least 80% or at least 90%. Particularly, the object beam is diffracted by the active optical structure of the master in a further half-space limited by the main extension plane of the master, the further half-space being free of the light source emitting the reference beam.

During this embodiment of the method, the electromagnetic radiation of the reference beam emitted by the light source transmits the master and is diffracted by the active optical structure of the master. During transmission of the active optical structure of the master the optical information of the active optical structure is transferred to the electromagnetic radiation by diffraction such that the object beam carrying the optical information of the master is generated. The object beam interferes with the reference beam at the same time when it is generated so that the interference pattern is formed carrying the optical information of the master. The interference pattern is recorded by the recordation material.

According to a further embodiment of the method, the layer of the recordation material is arranged on or over a main surface of the master facing away from the half-space with the light source. This is particularly the case, if the master is transmissive for the electromagnetic radiation of the reference beam.

According to a further embodiment of the method, the reference beam has a beam cross-section radiating the active optical structure of the master as a whole.

For example, the reference beam has a beam cross-section radiating at least 50% of the first main surface and/or the second main surface of the master or at least 80% of the first main surface and/or the second main surface of the master. For example, the reference beam has a beam cross-section between and including 1 millimeter and 50 millimeter. Thus, the optical information of the master is transferred to the object beam during radiation with the reference beam at once.

According to a further embodiment of the method, the recordation material is in direct contact with the master. Particularly, the layer of the recordation material is applied directly to the first main surface and/or the second main surface of the master.

According to a further embodiment of the method, no measurements are undertaken for noise reduction. Particularly, no measurements for damping vibrations and/or measurements for pressure control of the environment are taken.

At present, a method for manufacturing a diffractive optical element is disclosed wherein a replication of the master, particularly of a volume phase hologram, is carried out with a light source emitting electromagnetic radiation with low coherence. The use of the light source emitting the reference beam of electromagnetic radiation with low coherence makes it possible to omit the use of noise reduction means necessary during the use of high coherence light sources, such as for example solid state lasers. In this way, manufacturing of the diffractive optical element can be simplified. Also, parasitic inference is avoided during the manufacturing of the diffractive optical element enhancing the quality of the diffractive optical element.

The method can be carried out by an apparatus described in the following. Therefore, embodiments, features and developments described in connection with the method can also be embodied by the apparatus and vice versa.

According to an embodiment, the apparatus for manufacturing a diffractive optical element includes a light source emitting electromagnetic radiation of a reference beam during operation.

According to an embodiment, the apparatus further includes a master covered with a layer of a recordation material.

According to an embodiment of the apparatus, the master is radiated with the electromagnetic radiation of the reference beam, such that an object beam is generated during operation of the apparatus.

According to an embodiment of the apparatus, an interference pattern of the electromagnetic radiation of the reference beam and the electromagnetic radiation of the object beam is recorded by the recordation material during operation of the apparatus.

Particularly, the apparatus includes:
the light source emitting the electromagnetic radiation of the reference beam during operation,
the master covered with the layer of the recordation material, wherein, during operation:
the master is radiated with the electromagnetic radiation of the reference beam, such that the object beam is generated, and
the interference pattern of the electromagnetic radiation of the reference beam and the electromagnetic radiation of the object beam is recorded by the recordation material.

Particularly, the master tilts the coherence plane of the electromagnetic radiation of the reference beam simultaneously with the generation of the object beam. Particularly, the tilting of the coherence plane of the electromagnetic radiation of the object beam is not achieved by a separate element within the apparatus such as a prism or an additional diffraction grating.

The diffractive optical element manufactured with the apparatus and/or the method can be an optical combiner, an optical filter or an optical splitter. For example, the diffractive optical element is configured for the use in augmented reality applications or virtual reality applications.

### BRIEF DESCRIPTION OF THE DRAWINGS

Further advantageous embodiments and developments of the method for manufacturing a diffractive optical element and the apparatus for manufacturing a diffractive optical element result from the exemplary embodiment described below in connection with the Figures.

FIG. 1 shows a schematic view of an apparatus for manufacturing a diffractive optical element according to an exemplary embodiment.

FIG. 2 shows a schematic view of an apparatus for manufacturing a diffractive optical element according to a further exemplary embodiment.

FIGS. 3 to 6 show schematically stages of a method for manufacturing a diffractive optical element according to an exemplary embodiment.

FIG. 7 show schematically a stage of a method for manufacturing a diffractive optical element according to a further exemplary embodiment.

### DETAILED DESCRIPTION OF THE INVENTION

Equal or similar elements as well as elements of equal function are designated with the same reference signs in the Figures. The Figures and the proportions of the elements shown in the Figures are not regarded as being shown to scale. Rather, single elements, in particular layers, can be shown exaggerated in magnitude for the sake of better presentation and/or better understanding.

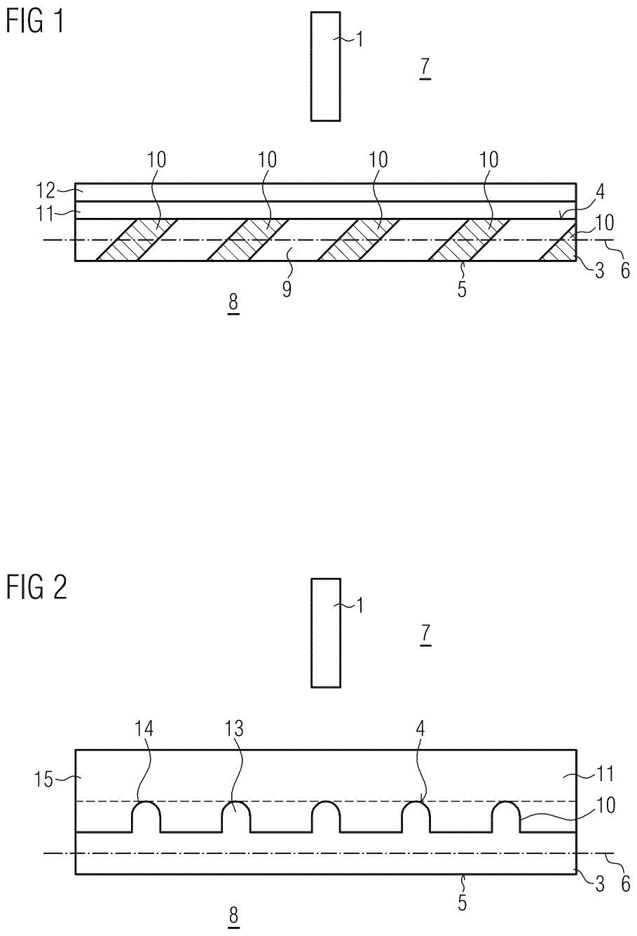

The apparatus for manufacturing a diffractive optical element according to the exemplary embodiment of FIG. 1 includes a light source 1, for example a light emitting diode or a semiconductor laser. During operation of the apparatus, the light source 1 emits electromagnetic radiation of a reference beam 2.

Further, the apparatus includes a master 3 with a first main surface 4 and a second main surface 5 opposite to the first main surface 4. A main extension plane 6 of the master 3 runs parallel to the first main surface 4 and to the second main surface 5 of the master 3. The main extension plane 6 limits a half-space 7, wherein the light source 1 is arranged, and a further half-space 8 being free of the light source 1. The first main surface 4 and the second main surface 5 limit a volume region 9 of the master 3. Within the volume region 9, the master 3 includes an active optical structure 10 carrying an optical information.

On the first main surface 4 of the master 3, a layer of a recordation material 11 is applied in direct contact. The layer of the recordation material 11 completely covers the first main surface 4. Furthermore, the layer of the recordation material 11 is applied to a carrier 12, for example a glass or plastic plate.

For example, the recordation material 11 is a photosensitive material, such as a photopolymer. The photosensitive material includes monomers being cross-linked to each other by radiation with electromagnetic radiation.

The master 3 of the apparatus according to the exemplary embodiment of FIG. 1 is, for example, a volume phase hologram. As shown, the active optical structure 10 is comprised by the volume region 9 of the master 3, while the first main surface 4 and the second main surface 5 of the master 3 are plane. In other words, the active optical structure 10 is completely arranged inside the master.

In contrast to the apparatus according to the exemplary embodiment of FIG. 1, the apparatus according to the exemplary embodiment of FIG. 2 includes a master 3 having a surface relief grating 13 within a first main surface 4 of the master 3. The surface relief grating 13 leads to a surface structure 14 within the first main surface 4 of the master 3.

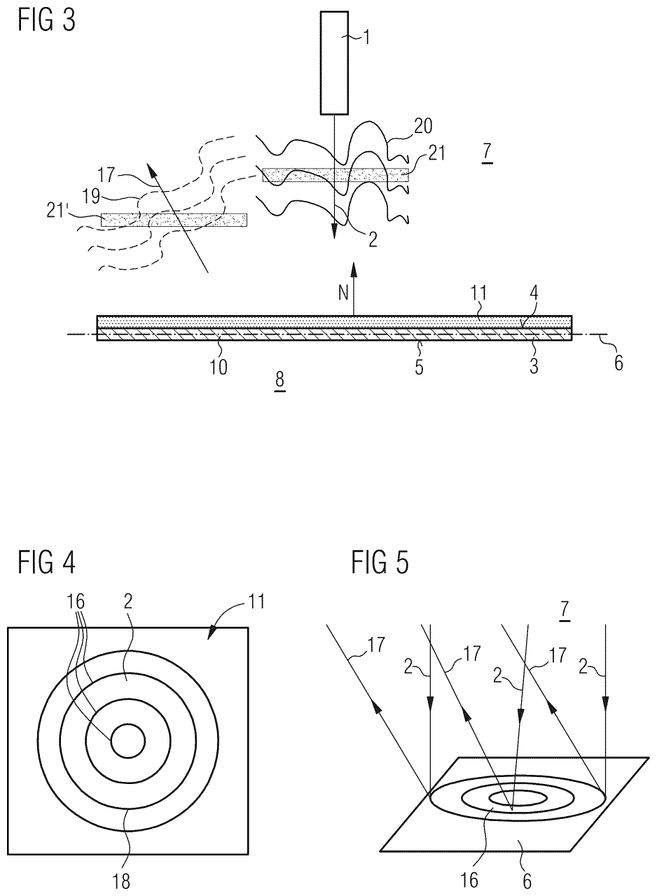

The master 3 is covered with a layer of a recordation material 11. Particularly, the recordation material 11 planarizes the surface structure 14 of the master 3 completely and extends in a direction normal to the first main surface 4 such that a sub-layer 15 of the recordation material 11 is formed over the first main surface 4 having a respective thickness in order to be able to record an interference pattern 16, as later described in connection with FIGS. 3 to 6.

The method according to the exemplary embodiment of FIGS. 3 to 6 can, for example, be carried out with an apparatus according to the exemplary embodiment of FIG. 1 or FIG. 2.

During the method for manufacturing a diffractive optical element according to the exemplary embodiment of FIGS. 3 to 6, a master 3 of the diffractive optical element to be manufactured is provided. Particularly, the diffractive optical element to be manufactured is a copy of the master 3. A first main surface 4 of the master 3 is covered with a layer of a recordation material 11, particularly with a layer of a photopolymer.

The master 3 is radiated with electromagnetic radiation of a reference beam 2. Electromagnetic radiation of the reference beam 2 is generated by a light source 1 of the apparatus, for example a laser diode or a light-emitting diode. Particularly, the electromagnetic radiation of the reference beam 2 has low coherence.

In the present exemplary embodiment, an active optical structure 10 of the master, is reflective for the electromagnetic radiation of the reference beam 2. When the reference beam 2 impinges on the active optical structure 10 of the master 3, the reference beam 2 is reflected such that an object beam 17 is generated. At present, the reference beam 2 has an incident angle of about 0° with a normal N of a main extension plane 6 of the master 3.

The object beam 17 is generated simultaneously during reflection and interferes with the reference beam 2 such that an interference pattern 16 is generated. The interference pattern 16 of the electromagnetic radiation of the object beam 17 and the electromagnetic radiation of the reference beam 2 is located within the recordation material 11 and exposes the recordation material 11 such that the interference pattern 16 is recorded in the recordation material 11.

At present, the object beam 17 is reflected in a half-space 7 limited by the main extension plane 6 of the master 3, wherein the light source 1 is arranged (FIG. 3).

FIG. 4 shows a plan view on the layer of the recordation material 11 on the first main surface 4 of the master 3 irradiated by the electromagnetic radiation of the reference beam 2, while FIG. 5 shows a perspective view.

The reference beam 2 has a beam cross-section 18 illuminating a large part of the first main surface 4. When the electromagnetic radiation of the reference beam 2 is reflected by the active optical structure 10 of the master 3, the object beam 17 is generated. The electromagnetic radiation of the object beam 17 has a wave front 19 different from a wave front 20 of the electromagnetic radiation of the reference beam 2.

The electromagnetic radiation of the reference beam 2 and the electromagnetic radiation of the object beam 17 overlap within the beam cross-section 18 of the reference beam 2 and form the interference pattern 16, which is recorded in the recordation material 11 due to exposure. So, the master 3 is copied within the beam cross-section 18 of the reference beam 2 in order to form the diffractive optical element to be manufactured.

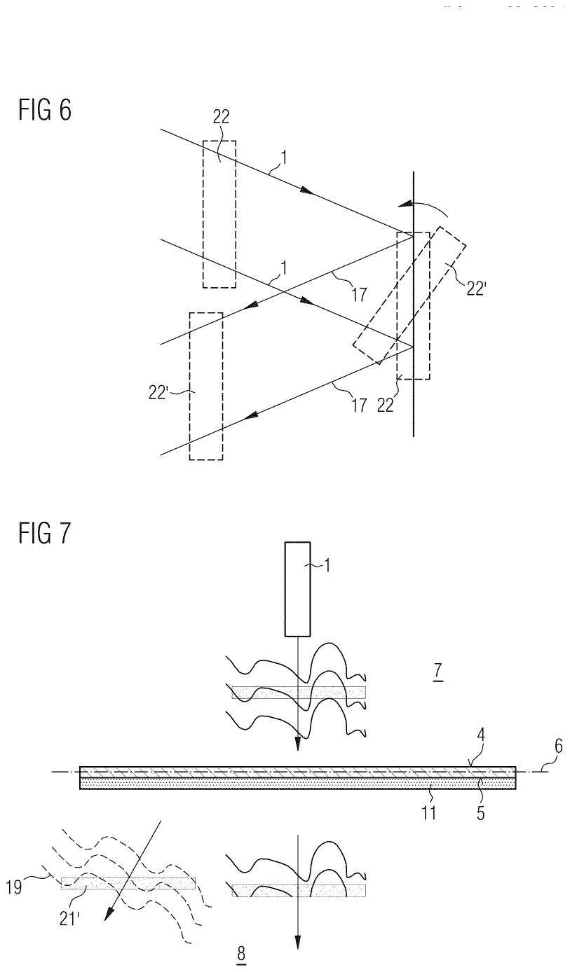

The reference beam 2 has a coherence volume 21 and the object beam 17 has a coherence volume 21′. A base area of the coherence volume forms the respective coherence plane 22, 22′. As schematically shown in FIG. 6, the active optical structure 10 of the master 3 tilts the coherence plane 22′ during the reflection of the electromagnetic radiation of the reference beam 2 such that the coherence plane 22 of the reference beam and of the coherence plane 22′ of the generated object beam 17 overlap, preferably completely.

After recordation of the interference pattern 16 of the electromagnetic radiation of the reference beam 2 and the electromagnetic radiation of the object beam 17 by the recordation material 11, the recordation material 11 is developed and the diffractive optical element is finished.

During the method of the exemplary embodiment according to FIGS. 3 to 6, the optical information of the active optical structure 10 of the master 3 is transferred to the electromagnetic radiation of the object beam 17 during reflection.

In contrast to the method for manufacturing a diffractive optical element according to the exemplary embodiment of FIGS. 3 to 6, during the method for manufacturing a diffractive optical element according to the exemplary embodiment of FIG. 7, a master 3 is transmissive for an electromagnetic radiation of a reference beam 2. Particularly, the electromagnetic radiation of the reference beam 2 is diffracted by an active optical structure 10 of the master 3 when the electromagnetic radiation of the reference beam 2 passes the master 3.

During the diffraction of the electromagnetic radiation of the reference beam 2 by the active optical structure 10 of the master 3, the object beam 17 is generated having a different wave front 20′ than the electromagnetic radiation of the reference beam 2. Particularly, the electromagnetic radiation of the object beam 17 extends in a further half-space 8 limited by a main extension plane 6 of the master 3, the further half-space 8 being free of a light source 1 emitting the electromagnetic radiation of the reference beam 2.

During diffraction of the electromagnetic radiation of the reference beam 2, the object beam 17 is generated carrying he optical information of the active optical structure 10 of the master 3. The electromagnetic radiation of the reference beam 2 and the electromagnetic radiation of the object beam 17 overlap and form an interference pattern 16, which is recorded by a recordation material 11. Particularly, a layer of the recordation material 11 is applied in direct contact to a second main surface 5 of the master 3 arranged opposite to a first main surface 4 of the master 3, the second main surface 5 of the master 3 facing away from the light source 1.

The present application claims priority of the German application DE 102023107190.4, the disclosure content of which is incorporated herein by reference.

The features and exemplary embodiments described in connection with the Figures can be combined with each other according to further exemplary embodiments, even if not all combinations are explicitly described. Furthermore, the exemplary embodiments described in connection with the Figures may alternatively or additionally have further features according to the description in the general part.

The invention is not limited to the description of the exemplary embodiments. Rather, the invention includes each new feature as well as each combination of features, particularly each combination of features of the claims, even if the feature or the combination of features itself is not explicitly given in the claims or the exemplary embodiments.

### REFERENCES

1 light source
2 reference beam
3 master
4 first main surface
5 second main surface
6 main extension plane
7 half-space
8 further half-space
9 volume region of the master
10 active optical structure
11 recordation material
12 carrier
13 surface relief grating
14 surface structure
15 sub-layer
16 interference pattern
17 object beam
18 beam cross-section
19 wave front of object beam
20 wave front of the reference beam
21, 21′ coherence volume
22, 22′ coherence plane
N normal

1. A method for manufacturing a diffractive optical element, comprising the steps of:
providing master of the diffractive optical element, wherein a layer of a recordation material covers the master,
radiating the master with electromagnetic radiation of a reference beam, such that an object beam is generated, and
recording an interference pattern of the electromagnetic radiation of the reference beam and an electromagnetic radiation of the object beam by the recordation material,
wherein
the diffractive optical element is a copy of the master.

2. The method according to the claim 1, wherein
the diffractive optical element is a volume phase hologram.

3. The method according to claim 1, wherein
the electromagnetic radiation of the reference beam is emitted by a light source, and
the light source is a light emitting diode or a semiconductor laser.

4. The method according to claim 1, wherein
the recordation material is a photopolymer.

5. The method according to claim 1, wherein
the master generates the electromagnetic radiation of the object beam such that a coherence volume of the electromagnetic radiation of the reference beam and a coherence volume of the electromagnetic radiation of the object beam overlap.

6. The method according to claim 5, wherein
the coherence volume of the electromagnetic radiation of the reference beam and the coherence volume of the electromagnetic radiation of the object beam overlap within the recordation material.

7. The method according to claim 1, wherein
the interference pattern is formed by the overlap of the coherence volume of the electromagnetic radiation of the reference beam with the coherence volume of the electromagnetic radiation of the object beam.

8. The method according to claim 1, wherein
the master is reflective for the electromagnetic radiation of the reference beam, and
the object beam is reflected by an active optical structure of the master in a half-space limited-limited by a main extension plane of the master, the half-space comprising the light source emitting the reference beam.

9. The method according to the previous claim 8, wherein
the layer of the recordation material is arranged on or over a main surface of master facing the half-space with the light source.

10. The method according to claim 1, wherein
the master is transmissive for the electromagnetic radiation of the reference beam, and
the object beam is diffracted by the active optical structure of the master in a further half-space limited-limited by the main extension plane of the master, the further half-space being free of the light source emitting the reference beam.

11. The method according to claim 10, wherein
the layer of the recordation material is arranged on or over a main surface of the master facing away from the half-space with light source.

12. The method according to claim 1, wherein
the reference beam has a beam cross-section radiating the active optical structure of the master as a whole.

13. The method according to claim 1, wherein
the recordation material is in direct contact with the master.

14. The method according to claim 1, wherein
no measurements for noise-reduction are taken.

15. An apparatus for manufacturing a diffractive optical element, comprising:
a light source emitting electromagnetic radiation of a reference beam during operation,
master covered with a layer of a recordation material,
wherein, during operation:
the master is radiated with the electromagnetic radiation of the reference beam, such that an object beam is generated, and
an interference pattern of the electromagnetic radiation of the reference beam and the electromagnetic radiation of the object beam is recorded by the recordation material,
the diffractive optical element is a copy of the master.
